(19) United States
(12) Patent Application Publication
(10) Pub. No.: US 2014/0320506 A1
(43) Pub. Date: Oct. 30, 2014

(54) MANIPULATING, CAPTURING, AND CONSTRAINING MOVEMENT

(71) Applicant: CHERIF ATIA ALGREATLY, Newark, CA (US)

(72) Inventor: CHERIF ATIA ALGREATLY, Newark, CA (US)

(73) Assignee: CHERIF ATIA ALGREATLY, Newark, CA (US)

(21) Appl. No.: 14/265,355

(22) Filed: Apr. 29, 2014

Related U.S. Application Data
(60) Provisional application No. 61/854,770, filed on Apr. 30, 2013.

(51) Int. Cl. G06T 13/80

(52) U.S. Cl. CPC G06T 13/80
USPC 345/473

(57) ABSTRACT

A method is disclosed for manipulating the movement of a user's body to achieve a task according to specific rules. This method can be utilized in various training, medical and rehabilitation applications. Another method for capturing the movement of a user' body is disclosed. This method can be used in different gaming, filmmaking and computer applications. Also, a method is disclosed for constraining the movement of a user's body according to an imaginary or virtual object. This method can be employed in several virtual reality and augmented reality applications.

### CROSS-REFERENCE TO RELATED APPLICATION

This application claims the benefits of a U.S. Provisional Patent Application No. 61/854,770, filed Apr. 30, 2013.

### BACKGROUND

Thus far there has not been a distinctly simple technique to track the motion of a human body. This is quite unfortunate, as motion tracking has broad applications in many fields including entertainment, gaming, sports, medical and robotics. For example, in filmmaking, motion tracking is used to record actions of human actors and transpose that information to create animated digital character models in 2D or 3D. In game development as well, motion capture is used to animate athletes to simulate authentic seeming martial art move and other in-game character actions. There are three main techniques that are currently used to track the motion of a human body but each has disadvantages.

The first technique is an optical system that utilizes cameras to track the acting human's motions via markers placed on different joints of the actor's body; This method requires expensive hardware and extensive post processing, while also lacking the ability to capture motion when markers are occluded for a prolonged period of time. Furthermore, motion capture must be carried out in a controlled environment away from yellow light and reflective noise, which can falsely manipulate the data.

The second technique utilizes magnetic trackers and involves using magnetic sensors to track motion. Its drawbacks include an innate sensitivity to metals, which can cause irregular outputs; performers using this technique are inherently constrained by cables in most cases; and the capture area is usually under a space constraint. The third technique involves electromechanical body suits, which tend to have low sample rates, and wearing the suit inherently applies constraints on human joints due to its sheer obtrusive nature attributed to the amount of required hardware.

The present invention overcomes all the previous noted disadvantages of the three aforementioned techniques, while also providing the ability to manipulate and constrain the movement of a human body at will. Manipulation and constraining of the movement can be used in various training, entertainment, medical, rehabilitation, and computer applications, as will be described subsequently.

### SUMMARY

The present invention discloses a method for manipulating the movement of a user's body to achieve certain task. This can be fruitfully used in various training, medical, and rehabilitation applications. In training applications for example, the present invention can manipulate the user's body to move in the necessary manner when practicing a sport or musical instrument, relieving the need for a professional trainer. In medical applications, the physician can perform medical operations, while simultaneously being assisted by a computer that guides the physician's hand movement, thus helping to correct any error that may occur due to inaccurate action on the physician's part during the medical operation. In therapy rehabilitation applications, the present invention can greatly assist patients seeking to improve or restore their physical strength by guiding their legs, arms, hands, and fingers into movement required by medical instructions, therefore removing the need for assistance from others. Also, the present invention prevents potentially damaging movement of a patient's body that can badly impact the patient's overall rehabilitation.

The present invention also discloses a second method for capturing the movement of a user's body. This is utilized in various gaming, filmmaking, and computer applications. For example, capturing the movement of a user's hand or fingers in the air or on a surface can be interpreted to provide a computer system with an immediate input, which can represent handwriting, computer mouse movement, keyboard keystrokes, or touchscreen interaction. Thus, the user can interact easier with a computer, tablet, mobile phone, and even an optical head-mounted display, such as GOOGLE GLASS, without a necessary computer input device. The main advantage of this method is that user's movement is accurately captured regardless of the user's location or the light exposure. The tracked data of the user's body is wirelessly sent, in real-time, to a device such as a computer, tablet, or mobile phone, or stored for later transfer to the device. This data allows a simulation of the shape and motion of the user's body to appear in three-dimensions on the device display.

The present invention discloses a third method for constraining the movement of a user's body. This can be utilized in various virtual reality and augmented reality applications. For example, a physician can sense the touch of a part of a patient's body when looking at the patient's medical images, offering the physician sensory clarification regarding the patient's physical condition. Also, the user of the present invention can sense with touch virtual objects presented on a computer display. This applies when watching movies that present people, animals, or birds, or when playing 3D games that include 3D characters or avatars. The user can also feel the touch of various objects whose pictures are printed in books, newspaper, or magazines, ultimately transforming printed material into interactive media, as will be described subsequently.

Overall, the above Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 illustrates a skeleton comprised of a plurality of joints connected to each other.

FIG. 2 illustrates rotating the joints to change the shape of the skeleton.

FIGS. 3 and 4 illustrate bending a finger by rotating the finger's joints.

FIGS. 5 to 7 illustrate moving different parts of a human's body by rotating the body joints in certain directions.

FIGS. 8 to 10 illustrate a simulated rotation method that shows a joint vertically or horizontally rotated using four strings, according to one embodiment of the present invention.

FIGS. 11 to 12 illustrate a manipulating the movement or rotation of a user's finger joints using four strings, according to one embodiment of the present invention.

FIG. 13 illustrates a skeleton of a human body indicating the joints of the different body parts.

FIG. 14 illustrates a block diagram indicating the steps of a method to manipulate the movement of a skeleton, according to one embodiment of the present invention.

FIG. 15 illustrates a block diagram indicating the steps of a method which captures the movement of a skeleton, according to one embodiment of the present invention.

FIG. 16 illustrates a block diagram describing the steps of a method which constrains the movement of a skeleton, according to one embodiment of the present invention.

### DETAILED DESCRIPTION

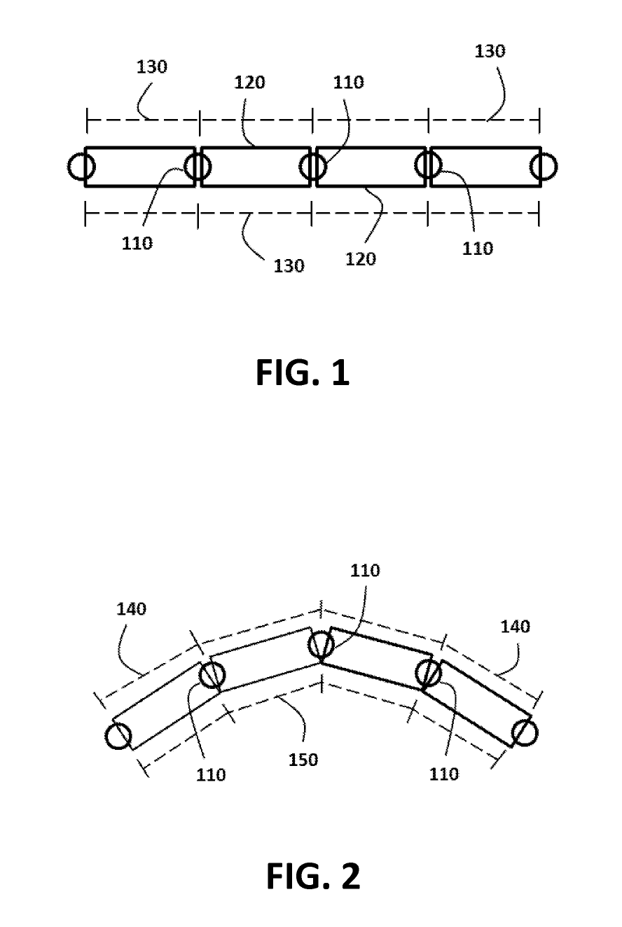

FIG. 1 illustrates a skeleton comprised of five joints 110 that can be rotated vertically or horizontally. The joints are connected to each other via connecting objects 120. The dotted lines 130 represent the distances between the joints. FIG. 2 illustrates rotating the joints to move or change the shape of the skeleton. As shown in this figure, the top length 140 of the skeleton increases because the surface of the top side of the skeleton expands after rotating the joints. Also, the bottom length 150 of the skeleton decreases due to the contraction of the bottom side of the skeleton after rotating the joints. Generally, the expansion of one side of the skeleton and the contraction of the other side of the skeleton happens when the joints are rotated vertically or horizontally. For example, if FIGS. 1 and 2 represent a top view of the skeleton, before and after the joints rotation, in this case, the joints are rotated horizontally. If FIGS. 1 and 2 represent a front view of the skeleton, before and after the joints rotation, the joints are seen as rotated vertically.

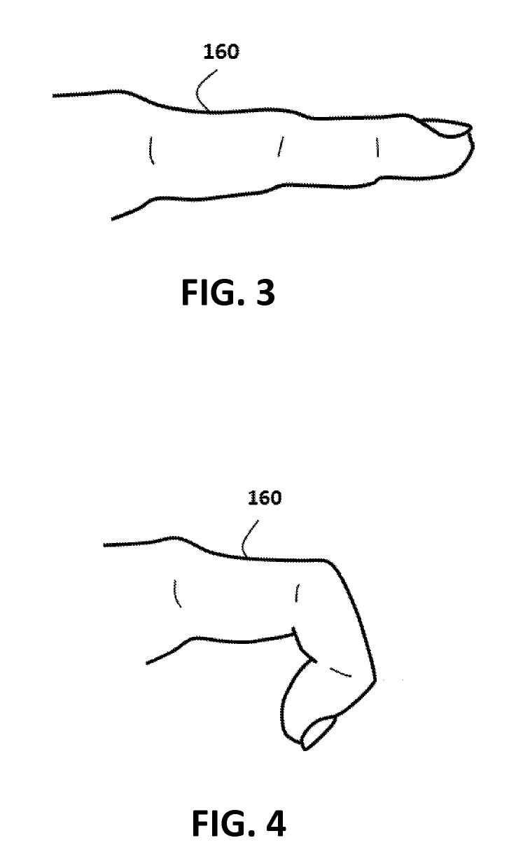

The skeleton of the previous example can be a skeleton of a person's finger, hand, arm, leg, or even entire body. In all such cases, there is always a side which expands and another side which contracts when one or more joints of a part of the person's body are rotated. In fact, the movement of the human's body happens because of the rotation of the different joints of the human's body. This rotation can be expressed as vertical or horizontal rotation. For example, FIGS. 3 and 4 illustrate bending a finger 160 by rotating the joints of the finger. As can be noted in FIG. 4, the length of the top side of the finger increased, while the length of the bottom side of the finger decreased. The finger's joint rotation causes the finger movement or bending. In this case, the expansion of the top finger skin and the contraction of the bottom finger skin allow the finger's bending.

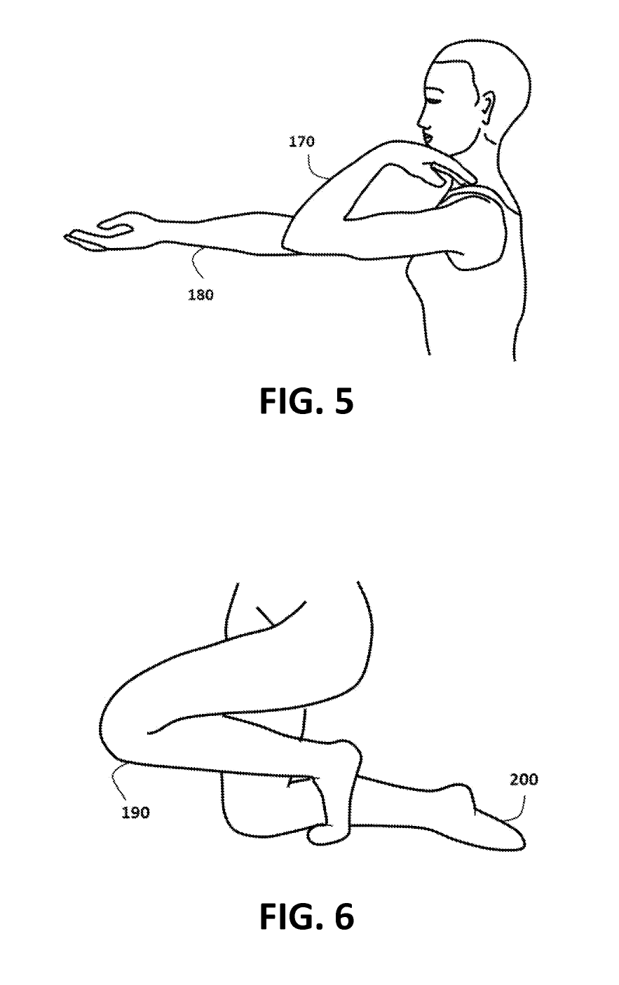

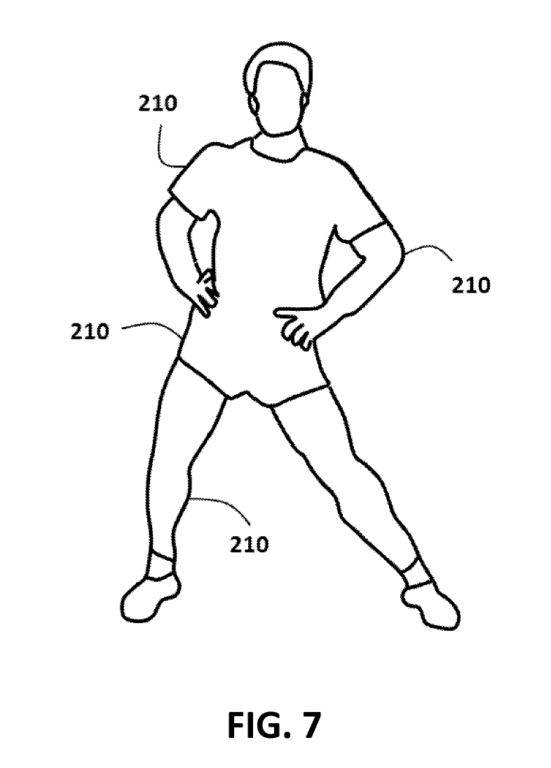

FIG. 5 illustrates a person bending her left arm 170 while straightening the right arm 180. As shown in the figure, the length of one side of the left arm increased while the length of the other side of the same left arm decreased. The same rule applies for the person's legs 190 and feet 200 illustrated in FIG. 6. Also, the same rule applies on the different parts 210 of the entire person's body as illustrated in FIG. 7.

Generally, manipulating, capturing, and constraining the expansion and contraction of the different parts of a skeleton comprised of joints, leads to manipulating, capturing, and constraining the movement of the skeleton. If the skeleton is a human body, this control of the movement of the human body can be fruitfully used in various training, medical, and rehabilitation applications. Capturing the human's body movement can be utilized in various gaming, filmmaking, and computer applications. Also, constraining movement can be employed in several virtual reality applications, as will be described subsequently.

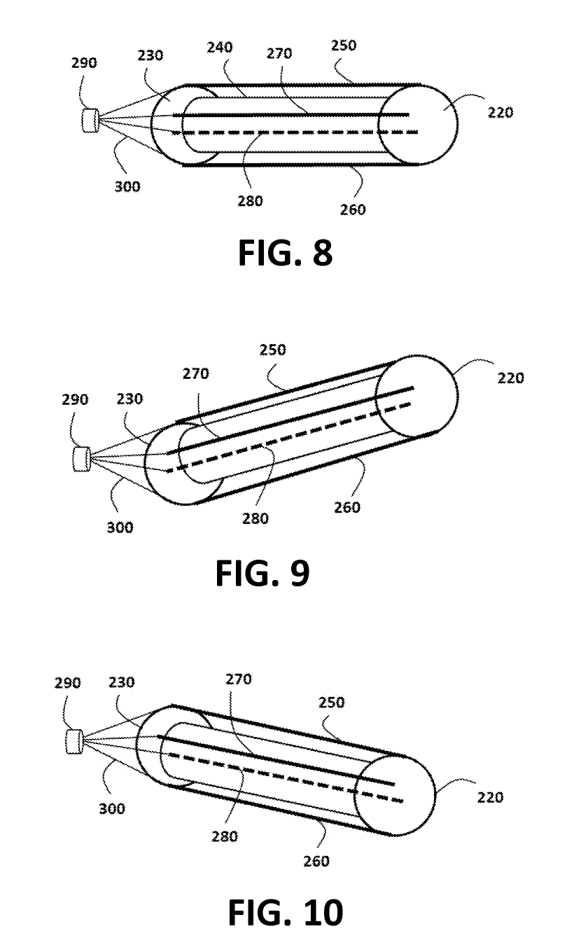

Generally, to manipulate, capture, or constrain the movement of a skeleton, a similar technique is used. For example, FIG. 8 illustrates a skeleton comprised of a first joint 220 and a second joint 230 that are connected via a connection object 240. Each one of the two joints can be rotated vertically or horizontally. As shown in the figure, a first string 250 and a second string 260 are connected to the top sides and bottom sides of the two joints. Also, a third string and a fourth string connected to the left sides and the right sides of the two joints. The first, second, third, and fourth strings are connected to a control unit 290 via four wires 300, where the control unit can release or pull each one of the four wires, consequently allowing each one of the four strings to expand or contract.

For example, FIG. 9 illustrates pulling the first strip 250, via the control unit, to vertically rotate the first joint in a counter-clockwise rotation. FIG. 10 illustrates pulling the second strip 260, via the control unit, to vertically rotate the first joint in a clockwise rotation. To rotate the first joint horizontally in a clockwise rotation, the third strip 270 is pulled by the control unit. To rotate the first joint horizontally in a counter-clockwise rotation, the fourth strip 280 is pulled by the control unit. Generally, to rotate the first joint vertically, one of the first and second strings is pulled, and to rotate the first joint horizontally one of the third and fourth strings is pulled.

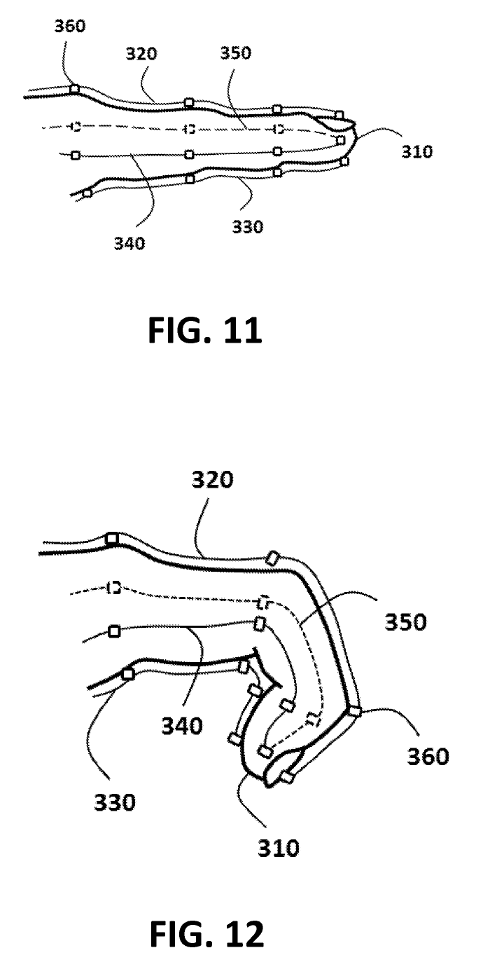

The concept of using four strings to vertically or horizontally rotate a joint can be used to influence the movement of the joints of a human's body. For example, FIG. 11 illustrates a finger 310 and first string 320 and a second string 330 connected to the top and bottom side of the finger. The third string 340 and fourth string 350 are connected to the left and right sides of the finger. Each string connects two successive joints of the finger to independently control the rotation of each joint. FIG. 12 illustrates pulling the second string to bend the finger. The small connections 360, in the two previous figures, attach each string to the finger at a position of a joint. In one embodiment of the present invention, the strings are made from fiber and embedded in a textile in the form of clothes designed to be worn by the user. This is a method which easily facilitates the attachment of the strings to the correct positions of the user's joints.

As mentioned previously, pulling or releasing the strips is achieved by a control unit in the form of electro-mechanical engine that pulls or releases each one of the strings as desired. To move a skeleton comprised of a plurality of joint in a desired movement, each rotation of a joint is determined by a CPU connected to the control unit. Determining the vertical and/or horizontal rotations of a joint leads to determining the magnitude of pulling or releasing each one of the strings.

Manipulating the movement of a user's body can be fruitfully used in various training, medical, and rehabilitation applications. In training applications, for example, the present invention can guide the user's body to move in the necessary manner when practicing a sport or musical instrument. The user is no longer in need of a professional trainer. In medical applications, a physician can perform medical operations while being assisted by a computer that guides the physician's hand movement, thus helping to correct any error that may occur due to inaccurate action on the physician's part during the medical operation. In therapy rehabilitation applications, the present invention can greatly assist patients who wish to improve or restore their physical strength by guiding their legs, arms, hands, and fingers into necessary movement required for a particular stretch or motion as directed by medical instructions, therefore removing the need for direct assistance from others. Also, the present invention prevents potentially damaging movement of a patient's body that may have a bad impact on the patient's overall rehabilitation.

To capture the movement of a skeleton comprised of a plurality of joints, the same concept of FIG. 8 is used, but instead the control unit is replaced by a sensing unit. In this case, each one of the four strings will follow the movement of the joint's rotation while the sensing unit senses the change of the length of the wires 300 that are connected to the four strings. Accordingly, in FIGS. 11 and 12, the first, second, third, and fourth strings will be connected to a sensing unit instead of a control unit. In one embodiment of the present invention, the sensing unit is comprised of a plurality of sensors that sense the tension force applied to the wires due to the movement of the strings with the joints rotations. The wires can be made from a flexible material to expand or contract according to the movement of the four strings.

Capturing the movement of a user's body can be successively utilized in gaming, filmmaking, and computer applications. For example, capturing the movement of a user's hand or fingers in the air or on a surface can be interpreted to provide a computer system with an immediate input representing a computer mouse movement, keyboard keystrokes, or touchscreen interaction. In these cases, the user of the present invention will move his/her hands like s/he would hold a real computer input device; where the detection of the hand or fingers movement provides immediate input to the computer system, replicating the output of a typical computer input device. Thus, the user can interact easily with a computer, tablet, mobile phone, as well as, optical head-mounted displays, such as GOOGLE GLASS, without a computer input device.

Also, the present invention facilitates communication between the computer system and several everyday human tools without additional connections. For example, it is possible for the user of the present invention to employ a regular pen as a computer pen input device. The user can write on a regular piece of paper using the regular pen while the present invention simultaneously detects the user's hand/finger motions and provides immediate text input to the computer system. The present invention converts a regular computer display into a touch screen where the user can move his/her finger to point at any specific icon or menu on the computer display, and the regular computer display will react as if it were a touchscreen. This is done by detecting the user's hand/finger movements relative to the computer display's position and dimensions to manipulate the icons or menus to interact with the movement of the user's hand/finger.

Moreover, the present invention can provide a warning tool to alert a user when s/he moves his/her body in an awkward position during different activities such as sleeping, working out, or lifting a heavy object that could injure his/her back or other body parts. In the 3D movie production techniques, the present invention gives a comprehensive yet inexpensive tool for CG-animation or 3D cartoon movies, where it is easy to capture the different motions of the performers to emulate or copy these motions into a movement for 3D cartoon characters.

In sports training and analysis, the present invention is a perfect tool that can be utilized in many applications that provide the computer system with data simulating the details of a user's body movements when practicing different sports, such as shooting a basketball into a net, kicking a ball in a soccer game, or swimming. The user can view the simulation of all such details on the computer display to recognize his/her mistakes. Also, collecting the data of the players' motions using the present invention facilitates the analysis of the entire game to locate the team's/individual's mistakes during a game. Also, the present invention facilitates remote interactive virtual sporting, where two or more players can participate and compete in playing games remotely: detection of each player's motions becomes an immediate input to the computer which can connect to the Internet and transfer the action of the player to the others in different locations. This allows for the involvement of several participants from different geographical locations.

A main advantage of this method is that the capturing of the movement is accurately achieved regardless of the user's location and the light exposure. The tracked data of the user's body is wirelessly sent in real-time, to a device such as a computer, tablet, or mobile phone, or stored for later transfer to the device. This data makes it possible to simulate the shape and motion of the user's body in three-dimensions on a device display.

To constrain the movement of a skeleton comprised of a plurality of joints, the same concept of FIG. 8 is used but with the addition of a sensing unit to simultaneously work with the control unit. In this case, the sensing unit tracks the joints rotations and provides this data to a CPU which determines the location of the different points of the skeleton. To stop the skeleton points at certain borders, the control unit pulls the four strings to a limit that constrains the rotation of the joints, halting the skeleton's movement at the designated borders.

In one embodiment of the present invention, the designated borders can represent a three-dimensional object presented on a computer display. This applies when watching movies that present people, animals, or birds or when playing 3D games that includes 3D characters or avatars. Also, the borders can represent a picture of a 3D object printed in book, newspaper, or medical image. Accordingly, a physician can sense with touch a part of a patient's body when looking at the patient's medical images of this part, therefor giving the physician new clarification of the patient's physical condition. This can be used successively in various virtual reality and augmented reality applications.

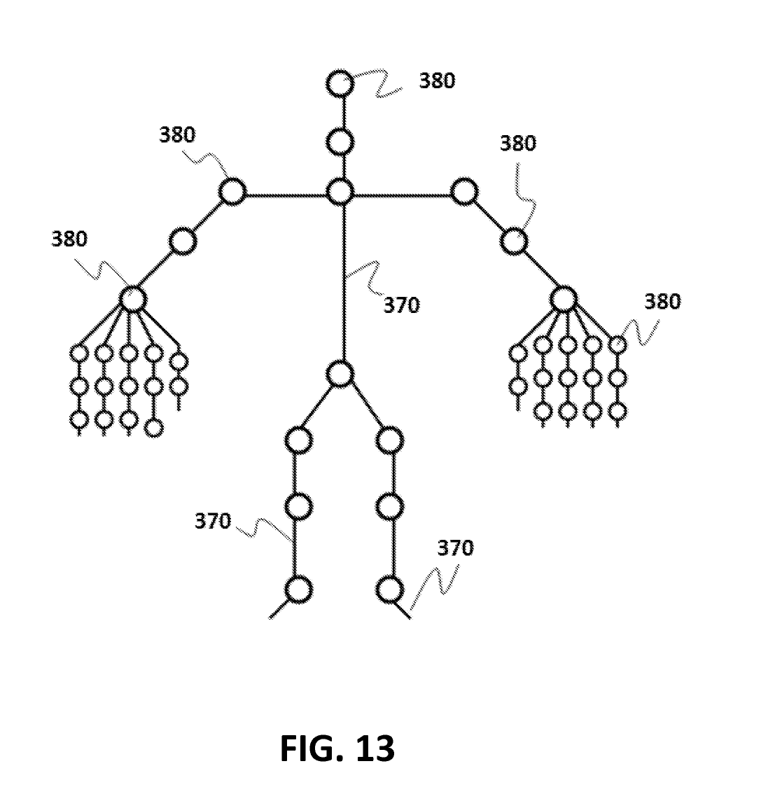

FIG. 13 illustrates a skeleton 370 of a human body, with main joints 380 that connect the fingers parts, the fingers and the palm, the palm and the wrist, the wrist and the forearm, the forearm and the arm, the arm and the shoulder, the abdominal and the thigh, the thigh and the leg, the leg and the ankle, and the ankle and the foot. It is very important to note that the movement of the human's body mainly depends on the rotation of its joints. For example, the finger joints, the hand joint, the elbow joint, the shoulder joint, and the leg joints move the human's body when one or more of them are rotated. The joint rotation can be horizontally parallel to an imaginary plane, vertically perpendicular to the imaginary plane, and/or axially about a central axis.

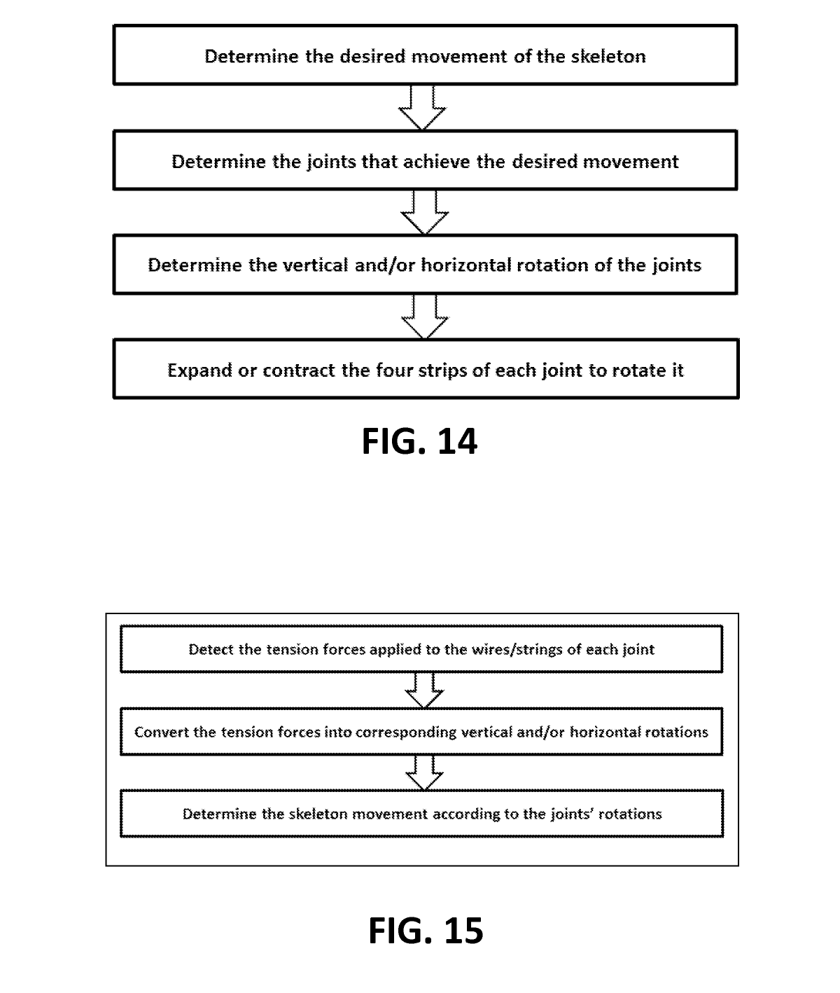

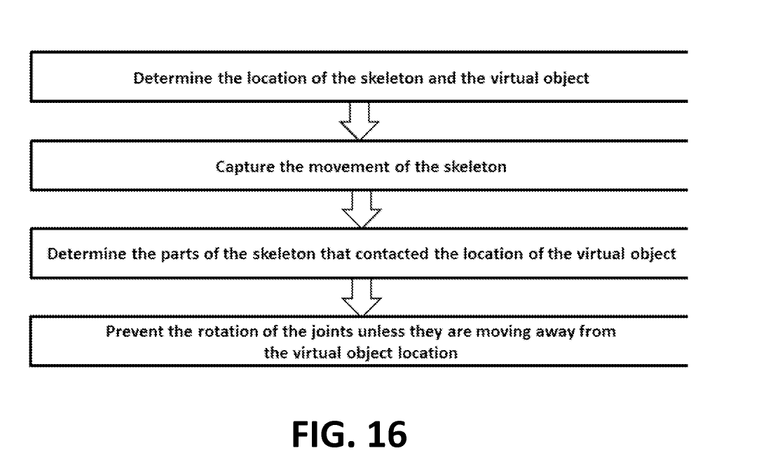

Finally, FIG. 14 illustrates a block diagram indicating the steps of a method to manipulate the movement of a skeleton, according to one embodiment of the present invention. FIG. 15 illustrates a block diagram indicating the steps of a method to capture the movement of a skeleton, according to one embodiment of the present invention. FIG. 16 illustrates a block diagram describing the steps of a method to constrain the movement of a skeleton, according to one embodiment of the present invention

Conclusively, while a number of exemplary embodiments have been presented in the description of the present invention, it should be understood that a vast number of variations exist, and these exemplary embodiments are merely representative examples, and are not intended to limit the scope, applicability or configuration of the disclosure in any way. Various of the above-disclosed and other features and functions, or alternative thereof, may be desirably combined into many other different systems or applications. Various presently unforeseen or unanticipated alternatives, modifications variations, or improvements therein or thereon may be subsequently made by those skilled in the art which are also intended to be encompassed by the claims, below. Therefore, the foregoing description provides those of ordinary skill in the art with a convenient guide for implementation of the disclosure, and contemplates that various changes in the functions and arrangements of the described embodiments may be made without departing from the spirit and scope of the disclosure defined by the claims thereto.

1. A method for manipulating the movement of a skeleton wherein the skeleton is comprised of joints connected to each other and the method comprising:
attaching a first strip and a second strip to connect each two successive joints of the joints wherein the contraction of the first strip or the second strip vertically rotates one of the two successive joints;
attaching a third strip and a fourth strip to connect each two successive joints of the joints wherein the contraction of the third strip or the fourth strip horizontally rotates one of the two successive joints;
determining the magnitudes of each contraction of the first strip, the second strip, the third strip, and fourth strip that rotate the joints in certain angles; and
contracting the first strip, the second strip, the third strip, and the fourth strip according to the magnitudes to manipulate the movement of the skeleton.

2. The method of claim 1 wherein the first strips, the second strips, the third strips, and the fourth strips are embedded in a textile in the form of clothes to be worn by a user.

3. The method of claim 1 wherein the contractions of the first strips, the second strips, the third strips, and the fourth strips are controlled by an electro-mechanical engine.

4. The method of claim 1 wherein the contraction of the first strip and the contraction of the second strip vertically rotate the joint in two opposite directions, and the contraction of the third strip and the contraction of the fourth strip horizontally rotate the joint in two opposite direction.

5. The method of claim 1 wherein the skeleton is a user's body and the movement is corresponding to certain criteria or rules.

6. The method of claim 5 wherein the certain criteria or rules represent instructions for practicing a sport.

7. The method of claim 5 wherein the certain criteria or rules represent instructions for playing a musical instrument.

8. The method of claim 5 wherein the certain criteria or rules represent medical instructions for improving or restoring physical strength.

9. A method for capturing the movement of a skeleton wherein the skeleton is comprised of joints connected to each other, and the method comprising:
attaching a first strip and a second strip to connect each two successive joints of the joints wherein the vertical rotation of one of the two successive joints contracts or expands one of the first strip and the second strip;
attaching a third strip and a fourth strip to connect each two successive joints of the joints wherein the horizontal rotation of one of the two successive joints contracts or expands one of the first strip and the second strip;
detecting the contractions and expansions of the first strips, the second strips, the third strips, the fourth strips, and
analyzing the contractions and expansions to capture the movement of the skeleton.

10. The method of claim 9 wherein the first strips, the second strips, the third strips, and the fourth strips are embedded in a textile in the form of clothes to be worn by a user.

11. The method of claim 9 wherein the first strip, the second strip, the third strip, and the fourth strip are connected to a sensor that senses the contractions and expansions.

12. The method of claim 9 wherein the skeleton is a user's hand and the movement is interpreted to provide a computer system with an immediate input representing hand writing, mouse movement, keystrokes of a keyboard, or a position on a touchscreen.

13. The method of claim 9 wherein the skeleton is a user's hand and the movement is interpreted to provide the computer system of an optical head-mounted display with an immediate input representing an interaction with a virtual data presented on the optical head mounted display.

14. The method of claim 9 wherein the skeleton is a user's hands and the movement represents sculpturing a three-dimensional virtual object on a computer display

15. The method of claim 1 wherein the skeleton is a user's body and the movement is simulated in real-time in three dimensions on a computer display.

16. A method for constraining the movement of a skeleton according to the imaginary position and shape of a virtual object, wherein the skeleton is comprised of joints connected to each other, and the method comprising:
attaching a first strip and a second strip to connect each two successive joints of the joints wherein the vertical rotation of one of the two successive joints is limited by the expansion of the first strip or the second strip;
attaching a third strip and a fourth strip to connect each two successive joints of the joints wherein the horizontal rotation of one of the two successive joints is limited by the expansion of the third strip or the fourth strip;
determining the imaginary position of the virtual object relative to each joint of the joints; and
limiting the rotation of each joints of the joint to constrain the movement of the skeleton at the boundary surface of the virtual object.

17. The method of claim 16 wherein the skeleton is a user's body and the virtual object represents a three-dimensional object presented on a computer display.

18. The method of claim 16 wherein the skeleton is a user's body and the virtual object represents a picture of a three-dimensional object presented in a printed material such as a book, newspaper, or magazine.

19. The method of claim 16 wherein the skeleton is a user's body and the virtual object represents another skeleton of another user's body.

20. The method of claim 16 further a tactile feedback such as forces, vibrations, or motions are applied to the skeleton at the points of contact with the virtual object.
